(19) United States
(12) Patent Application Publication
(10) Pub. No.: US 2014/0229450 A1
(43) Pub. Date: Aug. 14, 2014

(54) Method for Organising Blog Articles in a Social Network

(71) Applicants: Michael Brekelmans, Byron Bay NSW (AU); Paul Steven Dunn, Melbourne (AU)

(72) Inventors: Michael Brekelmans, Byron Bay NSW (AU); Paul Steven Dunn, Melbourne (AU)

(21) Appl. No.: 14/161,751

(22) Filed: Jan. 23, 2014

Related U.S. Application Data
(60) Provisional application No. 61/755,763, filed on Jan. 23, 2013.

(51) Int. Cl. G06F 17/30

(52) U.S. Cl. CPC G06F 17/30371; G06F 17/3089
USPC 707/691

(57) ABSTRACT

According to a first aspect of the present invention there is provided a method, implemented by a webserver in communication with a database, for facilitating blogging by members of a number of social networks, said members being in communication with the web-server via a data network, for example the Internet, the method comprising the steps of: capturing login information for a plurality of users, said login information identifying the users; prompting the users to enter blog entries on one or more topics; updating the database to associate the blog entries with respective users and topics; and publishing web-pages presenting topics with links to said blog entries associated therewith.

### CROSS REFERENCE TO RELATED APPLICATION

This application claims the benefit of and takes priority from U.S. Provisional Application Ser. No. 61/755,763, filed on Jan. 23, 2013, the contents of which are herein incorporated by reference.

### TECHNICAL FIELD

The present invention relates to social networking websites and to the provision of user generated blogs on web-pages of such websites.

### BACKGROUND INFORMATION

Many social media platforms, i.e. social and professional networking websites, allow for the creation of Groups/Networks of users that share a common interest. Furthermore, these platforms are also used by their members to leave messages and comments relating to various common topics of interest

However, if a user wishes to make a series of more in-depth messages then the usual procedure is for the user to make those independently of the social media platform.

This is undesirable for both the users and the website operator. It would be desirable for the user if they could leave a series of messages that are longer than simply comments, i.e. blog entries, in the web-pages of the social network that they are members of. Furthermore, it would be advantageous for the website operator if they could retain the blog content and user activity within their website.

It is an object of the present invention to provide a system and method which addresses the above problem or which is at least a useful alternative to those social networking methods and webservers that have hitherto been available.

### SUMMARY OF THE INVENTION

According to a first aspect of the present invention there is provided a method, implemented by a webserver in communication with a database, for facilitating blogging by members of a number of social networks, said members being in communication with the web-server via a data network, for example the Internet, the method comprising the steps of:

capturing login information for a plurality of users, said login information identifying the users;

prompting the users to enter blog entries on one or more topics;

updating the database to associate the blog entries with respective users and topics; and

publishing web-pages presenting topics with links to said blog entries associated therewith.

Preferably the database is arranged to associate many blogs with a topic and to associate many topics with a network.

Preferably the method includes presenting the users with options for saving, canceling or publishing their blog entries.

In a preferred embodiment of the invention the database includes a Blog table for storing the blog entries in association with a blog title and blog identifier.

Preferably the method includes operating the web-server to update the web-pages presenting topics with links to said blog entries in response to corresponding changes in the blog table.

In a preferred embodiment the method includes presenting the users with an option to view topic content including presenting a selection of blogs available for viewing that are associated with a selected topic.

Preferably the method includes, subsequent to having verified that the user is the creator of a particular blog, presenting options for the user to change the status of blog entries for the blog, including options to edit, save, delete or withdraw the blog from publication.

In a preferred embodiment of the present invention the method also includes prompting users to select a topic previously entered into the database.

The method may also include a step of prompting a user to enter a new topic and recording the new topic in the database.

Preferably the method further includes a step of processing a topic title entered by the user and storing it within the database.

In a preferred embodiment of the invention the database includes a Topic table and a Topic-Blog table which associates one or more blogs of the Blog table with a topic, wherein upon deletion of a Topic the associated blogs are deleted from the Blog table and said deletion is reflected in the corresponding published web-pages.

Preferably the method includes updating tables of the database including said Topic, Topic-Blog and Blog tables for changing the association of a blog to a topic to thereby allow a blog to be moved from one topic to another.

According to a further aspect of the present invention there is provided a non-transitory computer readable storage medium encoded with a computer program, the program comprising instructions that when executed by one or more processors of a web-server, cause said web-server to perform operations comprising:
capturing login information for a plurality of remote users, said login information identifying the users;
prompting the users to enter blog entries on one or more topics;
updating a database in communication with the webserver to associate the blog entries with respective users and topics; and
publishing web-pages presenting topics with links to said blog entries associated therewith.

Preferably the database is arranged to associate many blogs with a topic and to associate many topics with a network.

Preferably the computer readable storage medium further includes instructions for the web-server to perform the step of presenting the users with options for saving, canceling or publishing their blog entries.

In a preferred embodiment of the invention the database includes a Blog table for storing the blog entries in association with a blog title and blog identifier.

Preferably the computer readable storage medium further includes instructions for the web-server to perform the step of operating the webserver to update the web-pages presenting topics with links to said blog entries in response to corresponding changes in the blog table.

In a preferred embodiment the computer readable storage medium further includes instructions for the web-server to perform the step of presenting the users with an option to view topic content including presenting a selection of blogs available for viewing that are associated with a selected topic.

Preferably the computer readable storage medium further includes instructions for the web-server to perform the step of, subsequent to having verified that the user is the creator of a particular blog, presenting options for the user to change the status of blog entries for said blog, including options to edit, save, delete or withdraw the blog from publication.

Preferably the computer readable storage medium further includes instructions for the web-server to perform the step of prompting users to select a topic previously entered into the database.

The computer readable storage medium may further include instructions for the web-server to perform the step of prompting a user to enter a new topic and recording the new topic in the database.

Preferably the computer readable storage medium further includes instructions for the web-server to perform the step of processing a topic title entered by the user and storing it within the database.

In a preferred embodiment of the invention the database includes a Topic table and a Topic-Blog table which associates one or more blogs of the Blog table with a topic, wherein upon deletion of a Topic the associated blogs are deleted from the Blog table and said deletion is reflected in the corresponding published web-pages.

Preferably the computer readable storage medium further includes instructions for the web-server to perform the step of updating tables of the database including said Topic, Topic-Blog and Blog tables for changing the association of a blog to a topic to thereby allow a blog to be moved from one topic to another.

According to another aspect of the present invention there is provided a system including:
at least one web-server operable to interact with remote users via a data network and to:

capture login information for a plurality of the remote users, said login information identifying the users;
prompt the users to enter blog entries on one or more topics;
update a database in communication with the webserver to associate the blog entries with respective users and topics; and
publish web-pages presenting topics with links to said blog entries associated therewith.

### BRIEF DESCRIPTION OF DRAWINGS

FIG. 1—Illustrates a system according to a preferred embodiment of the invention for performing a method according to a preferred embodiment of the invention.

FIG. 2—Depicts an entity relationship diagram which shows the different elements that make up the system and the relationships in between them.

FIG. 3—Shows the Database Tables.

FIG. 4—Represents the Method of Operation.

FIG. 5a—Depicts the database tables in the original state before a new topic is created.

FIG. 5b—Depicts the database tables after a new topic is created.

FIG. 6a—Depicts the database tables in the original state before a topic is deleted.

FIG. 6b—Depicts the database tables after a topic is deleted.

FIG. 7a—Depicts the database tables in the original state before a new blog is created.

FIG. 7b—Depicts the database tables in after a new blog is created.

FIG. 8a—Depicts the database tables in the original state before a blog is deleted.

FIG. 8b—Depicts the database tables after a blog is deleted.

FIG. 9a—Depicts the database tables in the original state before moving a blog from topic.

FIG. 9b—Depicts the database tables after moving a blog from topic.

FIG. 10—Shows the entry point for Topics under the Network.

FIG. 11—Depicts bow a Blog is created.

### DESCRIPTION OF THE INVENTION

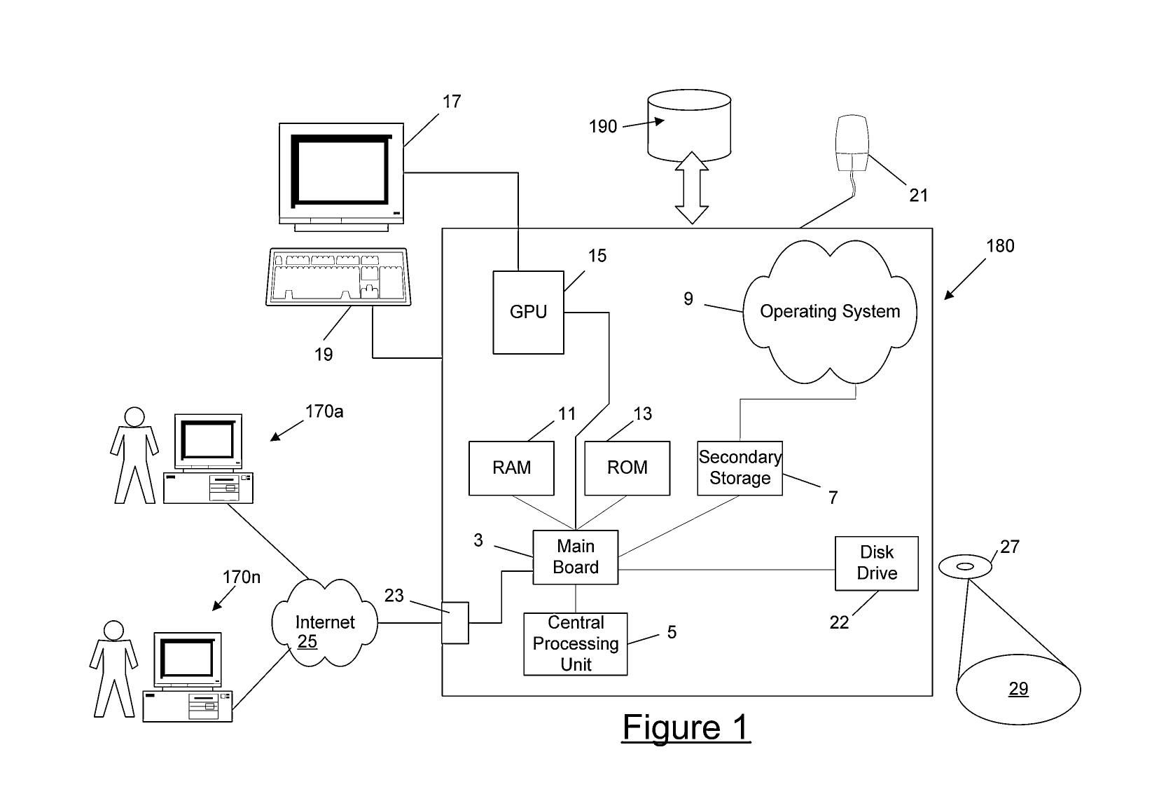

FIG. 1 illustrates the following elements:

Web-server 180: The social network is hosted on a web-server.

Database 190: The social networks data is stored in a database which is linked to the above Web-server.
More particularly, FIG. 1 includes a block diagram of an exemplary computer system 180 configured to operate as the web-server for carrying out a method according to an embodiment of the invention that will be described.
It will be understood that the computer system 1 comprises an exemplary electronic processor based system for carrying out the method.
The computer system 1 includes a main board 3 which includes circuitry for powering and interfacing to at least one onboard processor 5. The at least one onboard processor may comprise two or more discrete processors or processors with multiple processing cores.
The main board 3 acts as an interface between microprocessor 5 and secondary memory 7. The secondary memory 7 will typically comprise one or more optical or magnetic, or solid state, drives. The secondary memory 7 stores instructions for an operating system 9. The main board 3 also communicates with random access memory 11 and read only memory 13. The ROM 13 typically stores instructions for a Basic Input Output System (BIOS) which the microprocessor 5 accesses upon start up and which preps the microprocessor 5 for loading of the operating system 9.
The main board 3 also interfaces with a graphics processor unit 15. It will be understood that in some systems the graphics processor unit 15 is integrated into the main board 3.
The main board 3 will typically include a communications adapter, for example a LAN adaptor or a modem, that places the computer system 1 in data communication with a computer network such as the internet.
A user of the computer system 1 is able to interface directly with it by means of keyboard 19, mouse 21 and display 17. Alternatively, as is more often the case for servers an administrator may interface with the computer system across a data network by using a remote terminal application.
The user of system 1 may operate the operating system 9 to load social network serving software application. The software application is provided on product 29 is provided as tangible instructions borne upon a computer readable storage media such as optical disk 27. Alternatively it might also be downloaded via port 23.

Users 170a to 170n are able to communicate remotely with the webserver via a data network in the form of Internet 25: A User within the social network system is defined as a collection of demographical, biographical and supporting data surrounding a secured login.

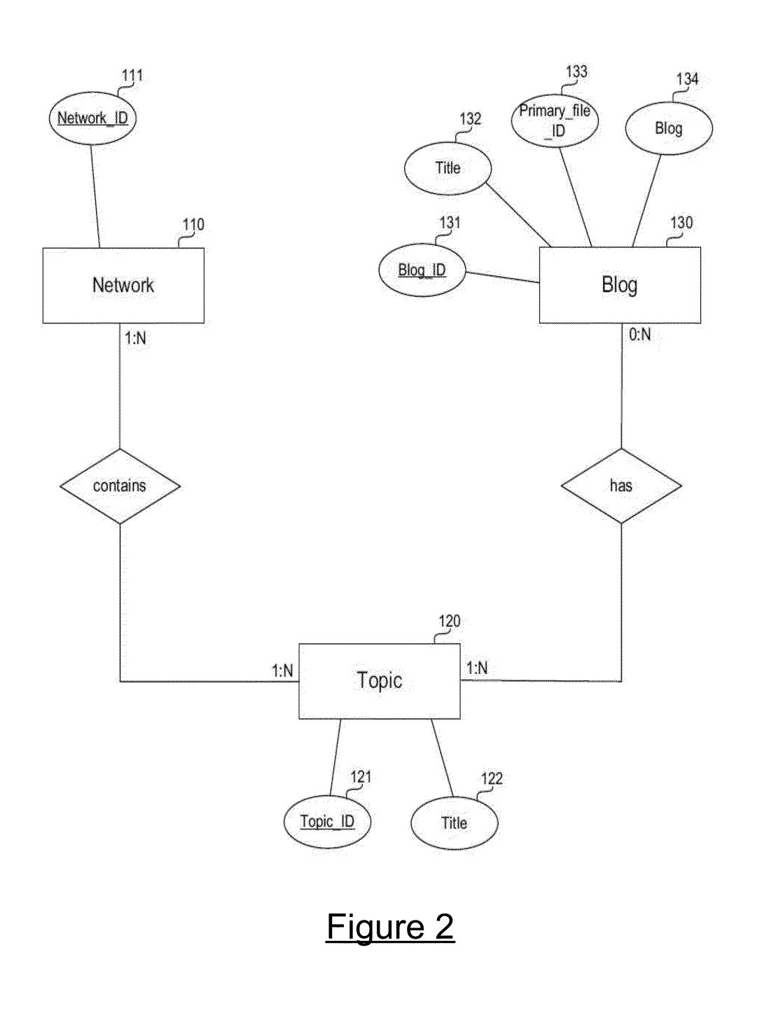

FIG. 2 depicts and Entity-Relationship diagram with the following elements:

Network 110: A Network within the social network system is defined as a collection of users grouped by a common/shared interest. A Network is defined in the database as Network_ID 111. A Network, as an emergent structure, can support direct data associations. For example, a Network can have data records linked to the Network, rather than to the Users that comprise it. A Network also enforces a level of security, preventing users outside of the Network from accessing content within the Network. A Network is created by a User.

Blog 130: A Blog (sometimes known as Page or Article) is a long-form, essay like, entity capable of containing hyperlinks, images, text and html markup (such as bold effects, italics, etc). A Blog is defined in the database as (BLOG_ID 131, TITLE 132, PRIMARY_FILE_ID 133, BLOG 134). Where the PRIMARY_FILE_ID 133 refers to a cover image, or avatar, for the blog.

Topic 120: A Topic within the social network system is defined as a collection of blogs grouped up by theme, subject or intention. A Topic is defined in the database as a (TOPIC_ID 121, TITLE 122).

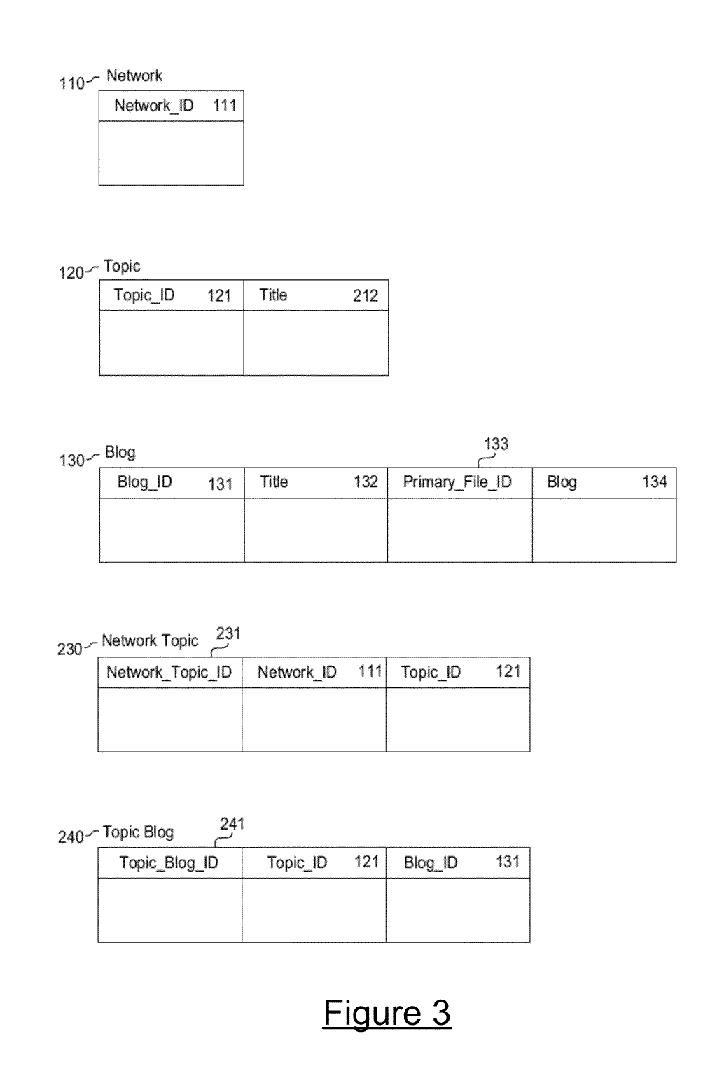

FIG. 3 shows the Database Tables:

Network Topics 230. Network Topics are a group of Topics that expound upon the central theme of the Network and allow for Blogs to be grouped up within a Network.

It is joined to a Network with the following Network_Topic table 230 (NETWORK_TOPIC_ID 231, NETWORK_ID 232, TOPIC_ID 233).

It is joined to a Blog with the following Topic_Blog table 240 (TOPIC_BLOG_ID 241, TOPIC_ID 242, BLOG_ID 243).

This creates a one-to-many relationship, where a Network can have multiple topics, and topics can have multiple blogs associated with it.

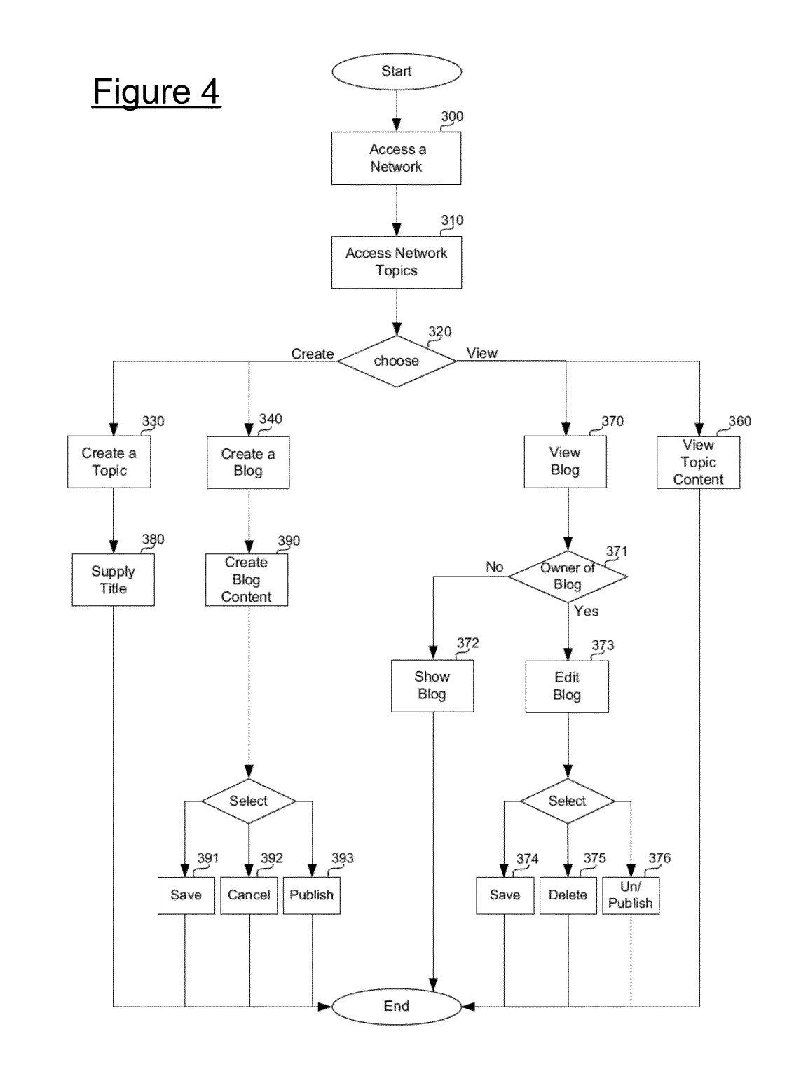

FIG. 4 represents the Method of Operation.

General flow:
1. Access the instance of a Network 300. The Network is a group of users, as described earlier.
2. Within that Network, access the Topics page 310 by clicking on the Topics link.
3. Choose 320:
   Create a Topic 330—Supply Title 380
   Create a Blog 340—Create Blog 390 content and: Save 391, Cancel 392, Publish 393
   View Topic Content 360—shows the blogs available within the Topic.
   View Blog 370—If the user is the owner of the Blog 371, then Edit Blog screen 373 is shown with the following options: Save 374, Delete 375, Un/Publish 376; otherwise the Blog Content is shown 372.

Specific:

1. Topic: A Topic is a group of Blogs (as defined earlier). It is necessary to allow the creation, update and deletion of Topics. A Topic is represented as text.

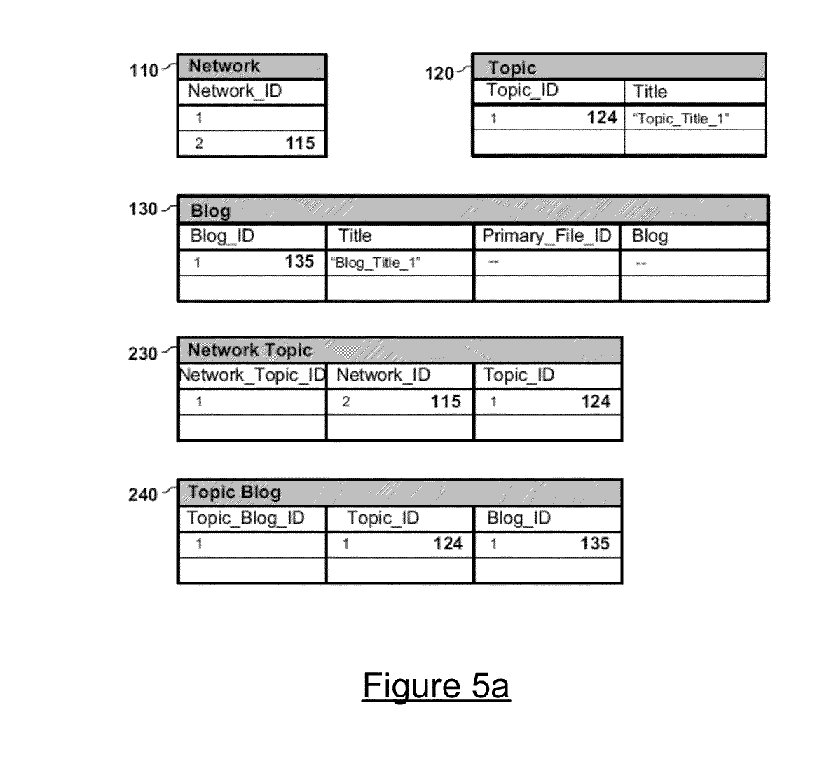

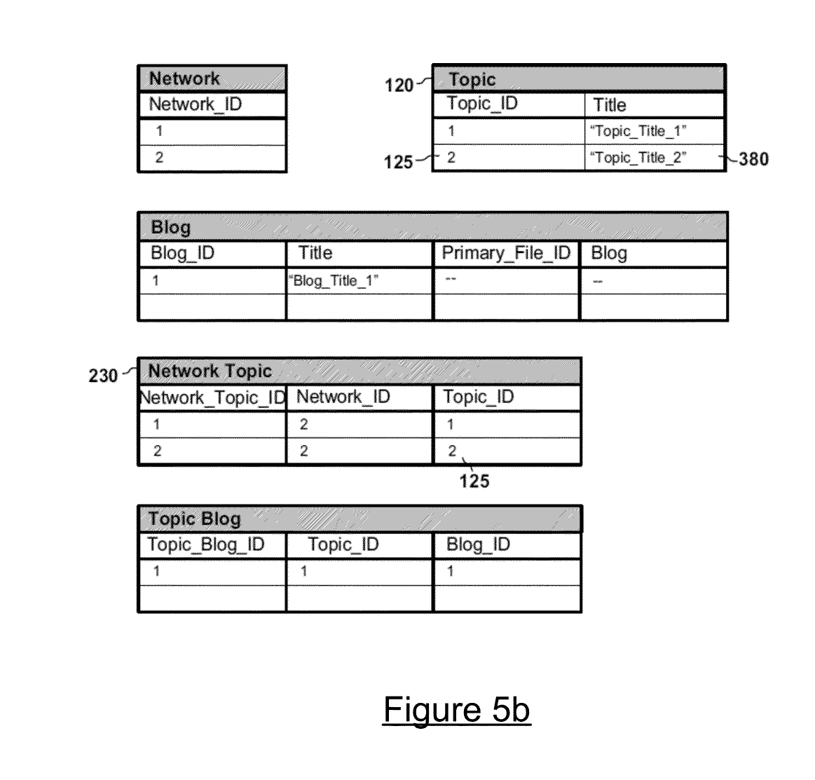

FIG. 5a—Depicts the database tables in the original state before a new topic is created. Network table 110 contains two networks with IDs 1 and 2 115 respectively. Topic table 120 has one Topic stored with ID 1 124. Blog table 130 contains one blog with ID 1 135. Network Topic table 230 creates a link between the only topic in the system with ID 1 124 and the Network with ID 2 115. Topic Blog table 240 creates a link between the only topic in the system with ID 1 124 and the only blog in the system with ID 1 135.

FIG. 5b—On insert, a topic title 380 is supplied by the user and a record inserted (TOPIC_ID 125, TITLE 380) into the Topic table 120 in the database. After that is done, the new Topic ID 125 is re-used and inserted into the Network_Topic table 230 to form the link between Network and Topic. In this figure the topic with ID 2 125 is linked to the network with ID 2 750 in the Network_Topic table 230.

The update of a Topic relates only to the Title 122 stored on the Topic table 120.

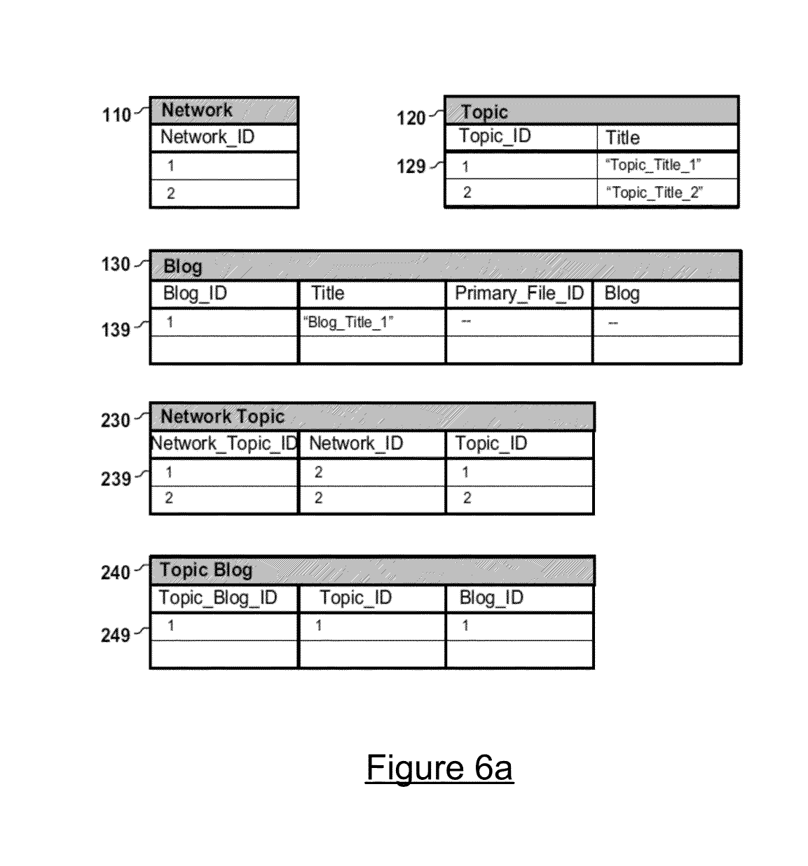

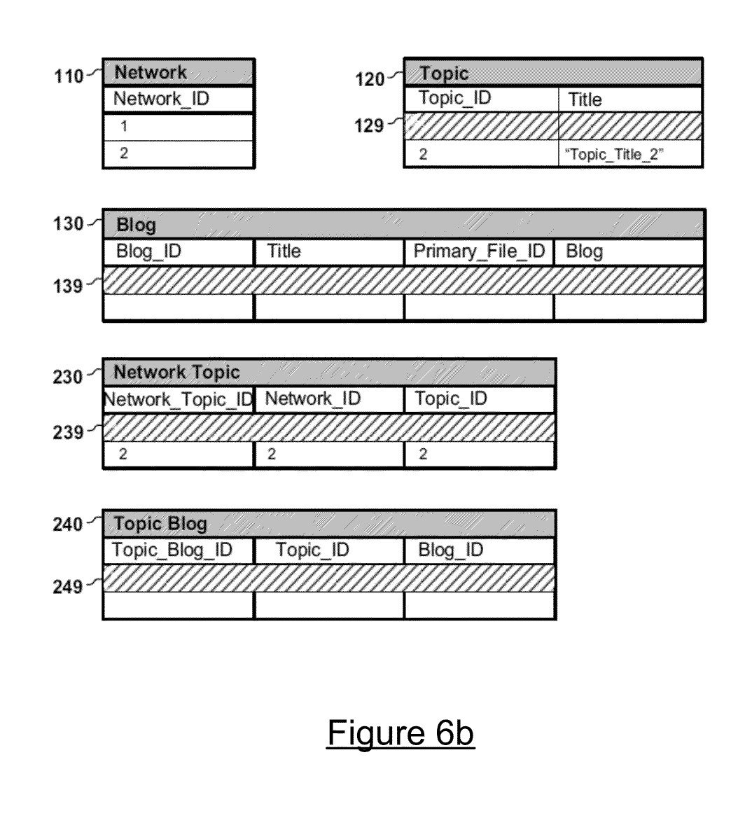

FIG. 6a—Depicts the database tables in the original state before a topic is deleted. Network table 110 contains two networks with IDs 1 and 2 respectively. Topic table 120 has two topics stored with ID 1 and 2. The record 129 in Topic table 120 for Topic_ID 1 will be deleted in the next step. Blog table 130 contains one blog with ID 1. The record 139 in Blog table 130 for Blog_ID 1 will be deleted in the next step. Network Topic table 230 creates a link between the topic in the system with ID 1 and the Network with ID 2 and the topic in the system with ID 2 and the Network with ID 2. The record 239 in Network Topic table 230 for Network_Topic_ID 1 will be deleted in the next step. Topic Blog table 240 creates a link between the topic in the system with ID 1 and the only blog in the system with ID 1. The record 249 in Topic Blog table 240 for Topic_Blog_ID 1 will be deleted in the next step.

FIG. 6b—Upon deletion of a Topic, the Blogs linked to it are deleted first from the Blog table 130. The blogs to delete are determined by the Topic_Blog table 240. Once the Blogs are deleted, then the Topic_Blog linking records are deleted. The Topic record itself is deleted. Finally, the Network_Topic 230 links that the topic referred to the now deleted. This removes all blogs, their links, the topic and its links from the database. In the example, Topic with ID 1 is deleted. For that, all the blogs linked to that topic are deleted. In FIG. 6a, in Topic_Blog table 240 all blogs linked to Topic_ID 1 will be deleted from the Blog table 130. The entry 249 reflects a link between Topic_ID 1 and Blog_ID 1. In FIG. 6b, in Blog table 130 the entry 139 has been deleted. In Topic_Blog table 240 the entry 249 is also deleted. In Topic table 120 the entry 129 which refers to Topic_ID 1 is also deleted. Finally, in Network_Topic table 230 the entry 239 is also deleted. 1

2. Blog 130:
There are two methods to create a blog—
   1. Directly create a new Blog entry.
   2. Create a new Blog entry as part of a Topic.

Both methods are available from the same button-click (Create Blog 340). If a Topic is currently selected, then the Blog will be defaulted to that Topic.

The user will then be prompted with a screen which will ask them to supply a title, an image, the blog content 390 and to nominate a Topic.

If the user needs to create a new topic at this point, then this is acceptable. If the user chooses to disregard the before-mentioned default and create a new topic, or change to another existing topic, this is acceptable.

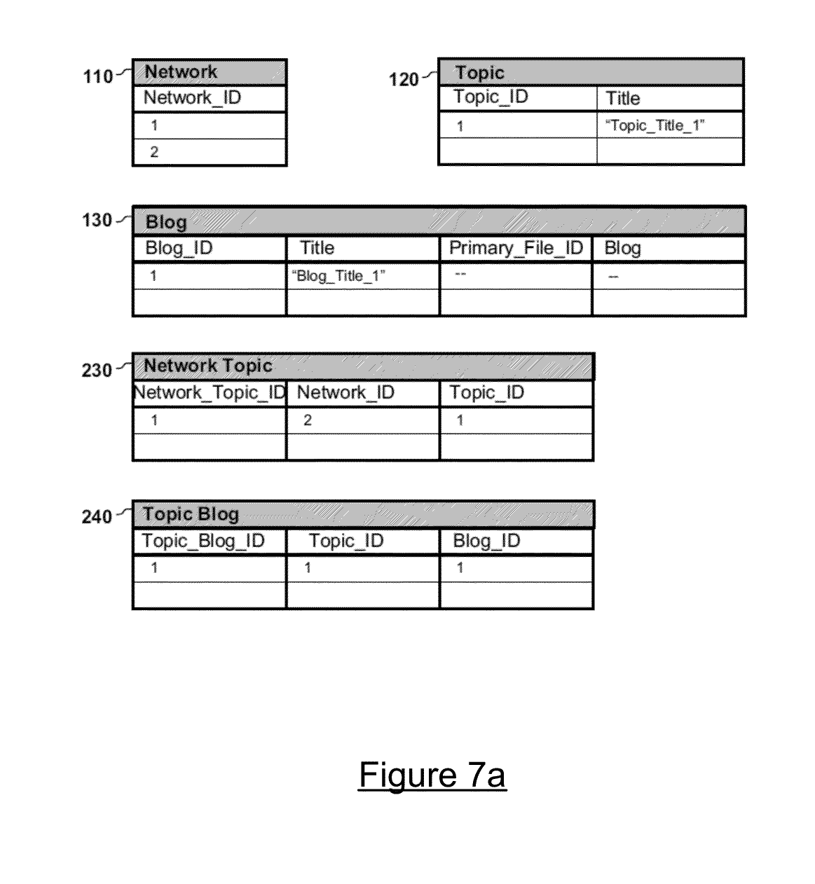

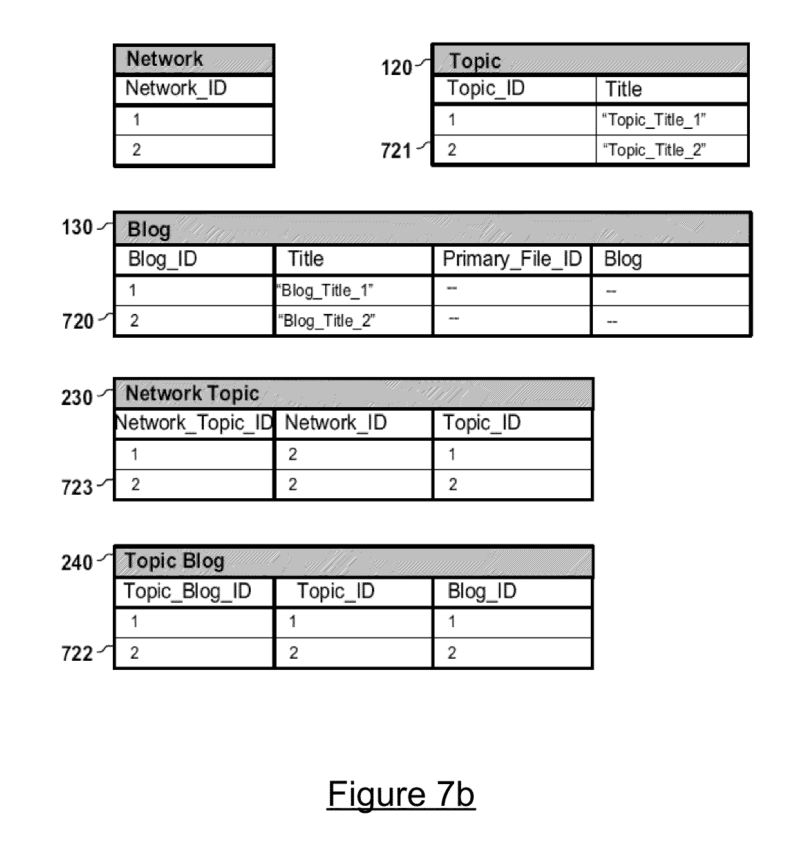

FIG. 7a—Depicts the database tables in the original state before a new blog is created. Network table 110 contains two networks with IDs 1 and 2 respectively. Topic table 120 has topic stored with ID 1. Blog table 130 contains one blog with ID 1. Network Topic table 230 creates a link between the topic in the system with ID 1 and the Network with ID 2 and the topic in the system with ID 2 and the Network with ID 2. Topic Blog table 240 creates a link between the topic in the system with ID 1 and the only blog in the system with ID 1.

FIG. 7b—Once the user has filled in the above details and clicked ‘Publish’ then a new record 720 is inserted into the Blog table 130. If a new topic is requested, then a record 721 is inserted into the Topic table 120, and a linking record 723 inserted into the Network_Topic table 230.

In all instances, a linking record 722 between the Topic and the Blog entry is inserted into the Topic_Blog table 240.

If a Blog is updated, then the Blog table 130 is updated.

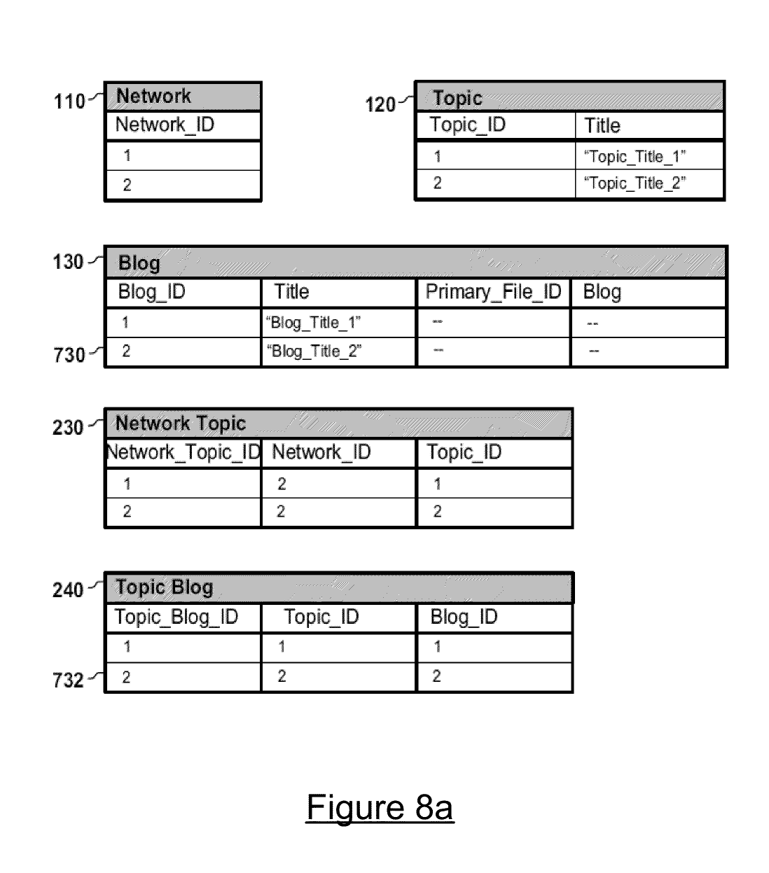

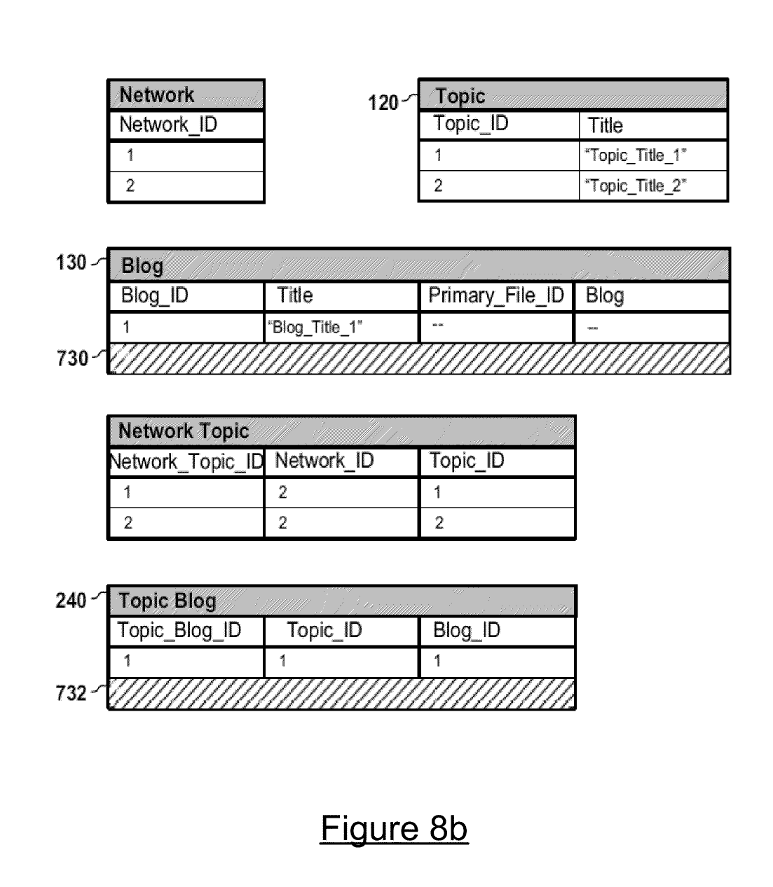

FIG. 8a—Depicts the database tables in the original state before a blog is deleted. Network table 110 contains two networks with IDs 1 and 2 respectively. Topic table 120 has two topics stored with ID 1 and 2. The record 730 in Blog table 130 for Blog_ID 2 will be deleted in the next step. Network Topic table 230 contains two links: between the topic in the system with ID 1 and the Network with ID 2; and between the topic in the system with ID 2 and the Network with ID 2. Topic Blog table 240 contains two links: between the topic in the system with ID 1 and the blog in the system with ID 1; and between the topic in the system with ID 2 and the blog in the system with ID 2 732. The record 732 in Topic Blog table 240 for Topic_Blog_ID 2 will be deleted in the next step.

FIG. 8b—If a Blog is deleted, in the example blog with ID 2, the entry 730 from the Blog table 130 is removed and the entry 732 from the Topic_Blog 240 is also removed. The Topic table 120 is untouched.

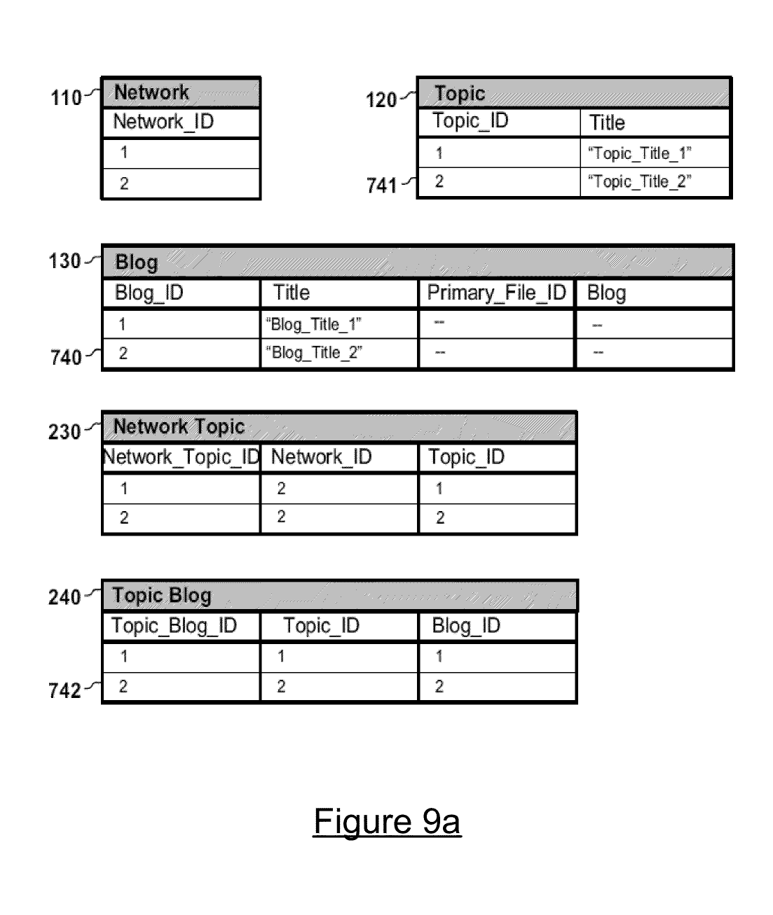

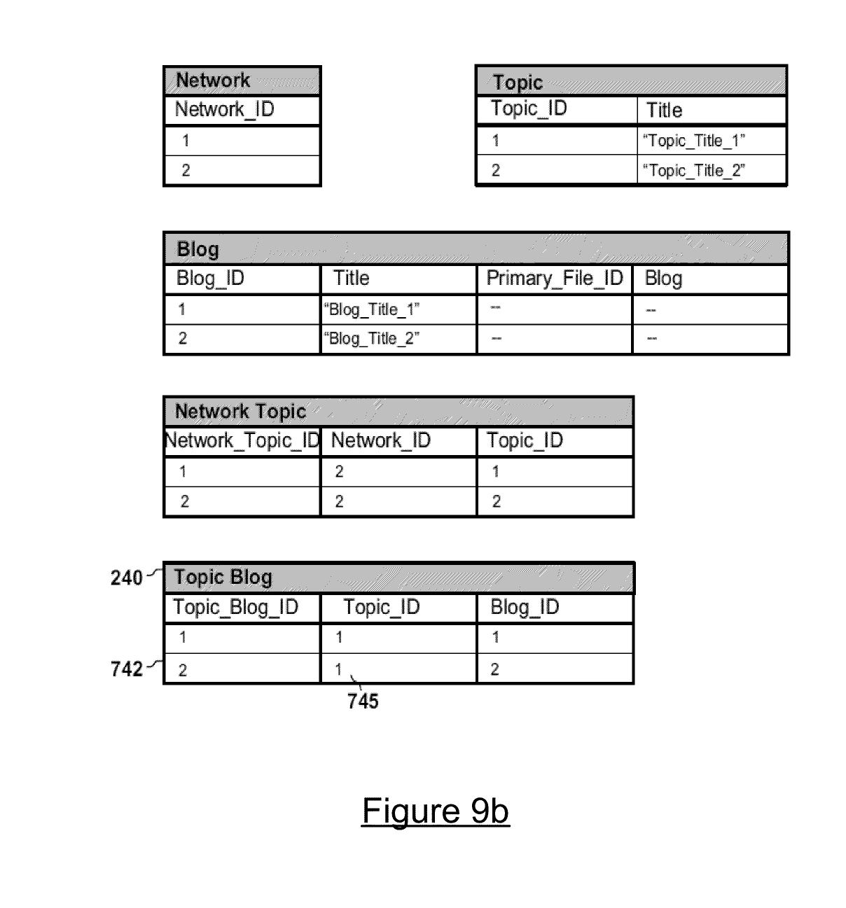

FIG. 9a—Depicts the database tables in the original state before moving a blog from topic. Network table 110 contains two networks with IDs 1 and 2 respectively. Topic table 120 has two topics stored with ID 1 and 2. The record 741 from Topic Table 120 Topic with ID 2 will be moved from the topic it currently belongs to in the next step. Blog table 130 contains two blogs with ID 1 and 2. The entry 740 represents all the information about the blog with ID 2 that will be moved in from topic with ID 2 to topic with ID 1. Network_Topic table 230 contains two links: between the topic in the system with ID 1 and the Network with ID 2; and between the topic in the system with ID 2 and the Network with ID 2. Topic_Blog table 240 contains two links: between the topic in the system with ID 1 and the blog in the system with ID 1; and between the topic in the system with ID 2 and the blog in the system with ID 2. The record 742 in Topic Blog table 240 for Topic_Blog_ID 2 will modified in the next step.

FIG. 9b—If a Blog entry is moved between Topics, then the Topic_Blog record 742 in the Topic_Blog table 240 is updated—the Topic ID 745 is switched to the new Topic.

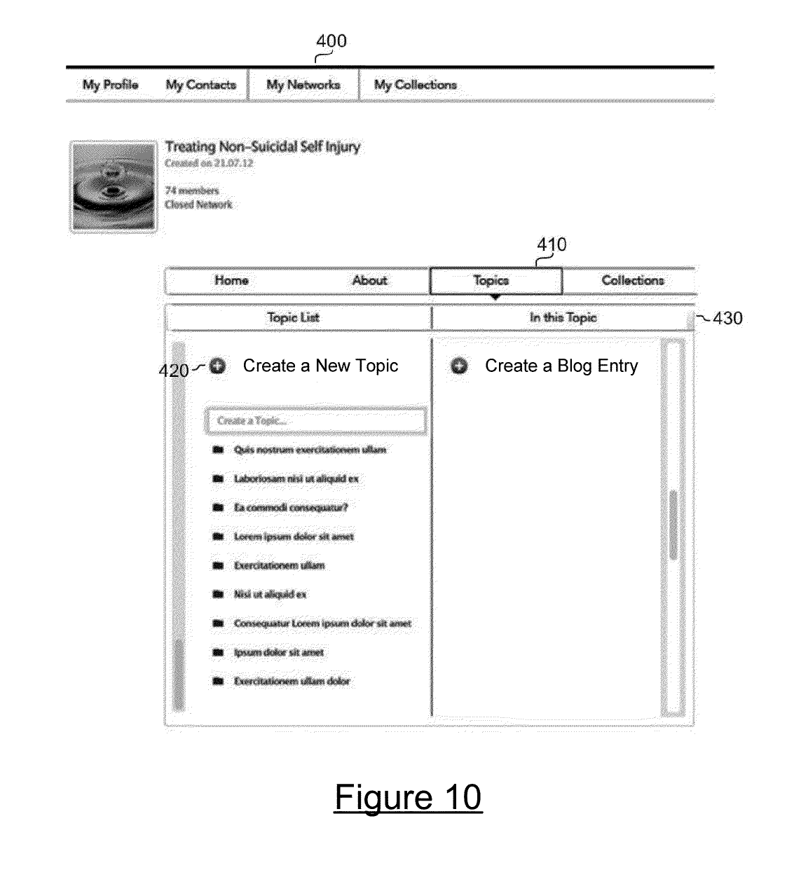

FIG. 10 shows the entry point for Topics 410 under the Network 400. The content in the left-hand side under the Topics button are the Topics themselves and reflect the content of Network_Topic 230 and Topic 120. The link from Topic to Network governs this display.

The ‘Create a New Topic’ 420 button creates the insert of records into the Topic and Network Topic table mentioned before. It also illustrates the scenario where a Topic has been selected and its associated B logs 430 are displayed in the right-hand column The blogs displayed are those which are linked via Topic Blog 240.

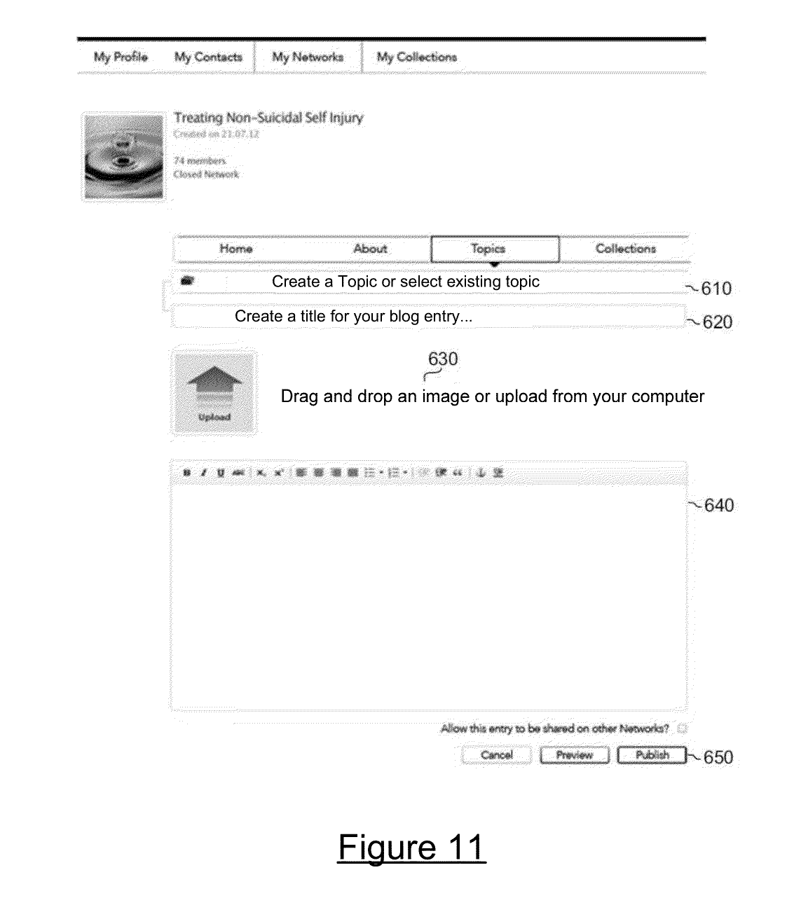

In FIG. 11, a Blog is created. The user has the option to create 610 Topic at this point, or select an existing topic. The user is expected to supply a title 620, a file 630 and the blog content 640.

Clicking Publish 650 will perform the database activities previously discussed.

Implementations of the present disclosure and all of the functional operations provided herein can be realized in digital electronic circuitry, or in computer software, firmware, or hardware, including the structures disclosed in this specification and their structural equivalents, or in combinations of one or more of them Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

What is claimed is:

1. A method implemented by a web-server in communication with a database for facilitating blogging by members of a number of social networks, said members being in communication with the web-server via a data network, the method comprising the steps of:
capturing login information for a plurality of users, said login information identifying the users;
prompting the users to enter blog entries on one or more topics;
updating the database to associate the blog entries with respective users and topics; and
publishing web-pages presenting topics with links to said blog entries associated therewith.

2. The method of claim 1, wherein the database is arranged to associate many blogs with a topic and to associate many topics with a network and wherein the method includes presenting the users with options for saving, canceling or publishing their blog entries.

3. The method of claim 1, wherein the database includes a Blog table for storing the blog entries in association with a blog title and blog identifier and wherein the method includes operating the web-server to update the web-pages presenting topics with links to said blog entries in response to corresponding changes in the blog table.

4. The method of claim 1, including presenting the users with an option to view topic content including presenting a selection of blogs available for viewing that are associated with a selected topic.

5. The method of claim 1, including, subsequent to having verified that the user is the creator of a particular blog, presenting options for the user to change the status of blog entries for the blog, including options to edit, save, delete or withdraw the blog from publication.

6. The method of claim 1, including prompting users to select a topic previously entered into the database.

7. The method of claim 6, including prompting a user to enter a new topic and recording the new topic in the database.

8. The method of claim 7, including processing a topic title entered by the user and storing it within the database.

9. The method of claim 1 wherein the database includes a Topic table and a Topic-Blog table which associates one or more blogs of the Blog table with a topic, wherein upon deletion of a Topic the associated blogs are deleted from the Blog table and said deletion is reflected in the corresponding published web-pages.

10. The method of claim 9, including updating tables of the database including said Topic, Topic-Blog and Blog tables for changing the association of a blog to a topic to thereby allow a blog to be moved from one topic to another.

11. A non-transitory computer readable storage medium encoded with a computer program, the program comprising instructions that when executed by one or more processors of a web-server, cause said web-server to perform operations comprising:
capturing login information for a plurality of remote users, said login information identifying the users;
prompting the users to enter blog entries on one or more topics;
updating a database in communication with the web-server to associate the blog entries with respective users and topics; and
publishing web-pages presenting topics with links to said blog entries associated therewith.

12. The computer readable storage medium of claim 11 including instructions for the web-server to perform the step of presenting the users with options for saving, canceling or publishing their blog entries.

13. The computer readable storage medium of claim 11 wherein the database includes a Blog table for storing the blog entries in association with a blog title and blog identifier and wherein said storage medium further includes instructions for the web-server to update the web-pages presenting topics with links to said blog entries in response to corresponding changes in the blog table.

14. The computer readable storage medium of claim 11 including instructions for the web-server to perform the step of presenting the users with an option to view topic content including presenting a selection of blogs available for viewing that are associated with a selected topic.

15. The computer readable storage medium of claim 14 including instructions for the web-server to perform the step of, subsequent to having verified that the user is the creator of a particular blog, presenting options for the user to change the status of blog entries for said blog, including options to edit, save, delete or withdraw the blog from publication.

16. The computer readable storage medium of claim 11 including instructions for the web-server to perform the step of prompting users to select a topic previously entered into the database.

17. The computer readable storage medium of claim 11 including instructions for the web-server to perform the step of prompting a user to enter a new topic and recording the new topic in the database.

18. The computer readable storage medium of claim 17 further including instructions for the web-server to perform the step of processing a topic title entered by the user and storing it within the database.

19. The computer readable storage medium of claim 18, wherein the database includes a Topic table and a Topic-Blog table which associates one or more blogs of the Blog table with a topic, wherein upon deletion of a Topic the associated blogs are deleted from the Blog table and and wherein said storage medium includes instructions for the webserver to reflect the deletion in the corresponding published web-pages.

20. The computer readable storage medium of claim 19 includes instructions for the web-server to perform the step of updating tables of the database including said Topic, Topic-Blog and Blog tables for changing the association of a blog to a topic to thereby allow a blog to be moved from one topic to another.

21. A system including:
at least one web-server operable to interact with remote users via a data network and to:
capture login information for a plurality of the remote users, said login information identifying the users;
prompt the users to enter blog entries on one or more topics;
update a database in communication with the webserver to associate the blog entries with respective users and topics; and
publish web-pages presenting topics with links to said blog entries associated therewith.
